(19) United States
(12) Patent Application Publication
(10) Pub. No.: US 2011/0177854 A1
(43) Pub. Date: Jul. 21, 2011

(54) APPARATUS AND METHOD FOR PLAYING AN ELECTRONIC TABLE CARD GAME

(76) Inventor: Julian J. Kennedy, Clemson, SC (US)

(21) Appl. No.: 13/008,889

(22) Filed: Jan. 18, 2011

Related U.S. Application Data
(60) Provisional application No. 61/295,705, filed on Jan. 16, 2010.

(51) Int. Cl. A63F 9/24; A63F 13/00

(52) U.S. Cl. 463/11; 463/30; 463/42; 463/27

(57) ABSTRACT

Electronic table card game apparatus and methods enable the play of multiplayer video table games by one or more players. Preferably, a system of multiple gaming terminal devices and a common display are employed to facilitate the play of multiplayer electronic table card games using the common display to display game play and the outcome of the multiplayer games. Each of the bar top terminal devices can either be used as a standalone single player gaming terminal or as a player station in the multiplayer game. In addition, the terminals can be configured to play single player and multiple player games simultaneously.

### CROSS REFERENCE TO RELATED APPLICATIONS

This application claims the benefit under 35 U.S.C. 119(e) of U.S. Provisional Application No. 61/295,705 filed Jan. 16, 2010, the disclosure of which is incorporated by reference herein.

### BACKGROUND OF THE INVENTION

1. Field of the Invention

The present invention relates to electronic table card game methods wherein one or more players participate in a multiplayer electronic table card game. More particularly, the present invention relates to improvements and new methods of operating video gaming devices to enable the play of multiplayer video table games.

2. Description of the Background Art

Multiplayer electronic table gaming devices are known. A multiplayer electronic table game sold under the registered trademark TABLEMAX utilizes in operation a common display for view of all game activity. U.S. Pat. Nos. 5,688,174, 6,921,337, 7,201,661, and 7,575,512 disclose various features that are employed in the TABLEMAX game and each includes the inventor of the claimed subject invention as the sole or a joint inventor. These patents are hereby incorporated by reference in their entirety.

US Published Patent Application 20090253480 entitled Multiplayer Interactive Video Gaming Device and published Oct. 8, 2009 to the same inventor as the subject application details various features of multiplayer card gaming devices including touch screen panels at player stations and server based gaming aspects. US Published Patent Application 20070018406 entitled Method of and Apparatus for Playing a Card Game and published Jan. 25, 2007 to the same inventor as the subject application details methods and apparatus of card game play. These published applications are also incorporated herein by reference.

Bar top gaming devices are well know within the gaming industry. Gaming companies IGT and Bally both manufacture these devices and they are currently in operation in numerous bars and casinos around the country. Various patents describe improvements and features of bar top gaming manufacturing and operation. For example, U.S. Design Pat. No. D460496 discloses a bar top gaming unit. Further, U.S. Pat. No. 5,655,966 details methods and apparatus for cashless bar top gaming machines.

Many configurations of bar top video gaming devices are available. These devices typically operate many versions of video poker card games and other games such as keno and bingo that are designed for one player. Many versions of video poker games are known such as “Deuces Wild,” “Bonus Poker,” and “Jacks or Better” which are just a few examples of the many available on bar top games. All these games will be referred to hereinafter as single player games.

### SUMMARY OF THE INVENTION

The present invention relates to improvements in electronic table card game apparatus and methods wherein one or more players participate in a multiplayer electronic table card game. More particularly, the present invention relates to improvements and new methods of operating video gaming devices to enable the play of multiplayer video table games.

In a number of embodiments, the invention employs a system of multiple bar top gaming terminal devices and a common display to facilitate the play of multiplayer electronic table card games using the common display to display game play and the outcome of the multiplayer games. Each of the bar top terminal devices can either be used as a standalone single player gaming terminal or as a player station in the multiplayer game. In addition, the terminals can preferably be configured to play single player and multiple player games simultaneously.

### BRIEF DESCRIPTION OF THE DRAWINGS

FIG. 1 shows a system of multiple bar top gaming terminal devices and a common display as employed in the preferred embodiments of the present invention to facilitate the play of multiplayer electronic table card games.

FIG. 2 shows a display view of a bar top gaming terminal as employed in the preferred embodiment of the present invention.

FIG. 3 shows a display view of a bar top gaming terminal utilized in operation of the methods of the present invention and described herein.

### DETAILED DESCRIPTION OF THE INVENTION

I. Method of Operating Bar Top Gaming Terminals to Enable Play of a Multiplayer Casino Card Game Using a Common Display

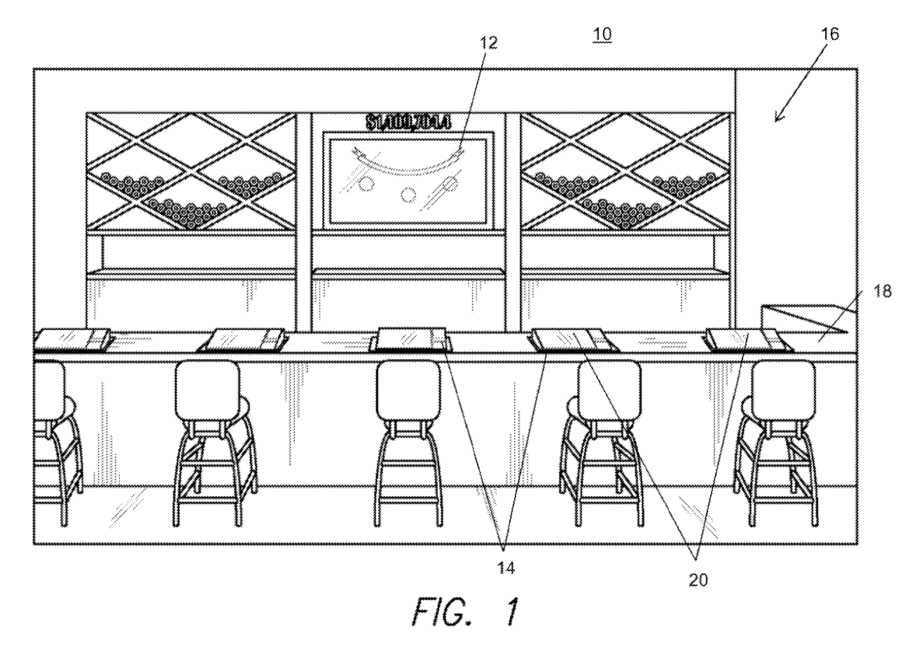

In one illustrative embodiment of the present invention, an apparatus and method are disclosed that enable one or more bar top gaming terminals to enable players to play a multiplayer video table card game. With reference to FIG. 1, a video gaming system 10 is illustrated in which a common video display 12 is mounted within viewing area of a plurality of bar top video gaming terminals 14. The bar top gaming terminals 14 are disposed within a bar 16. In this preferred embodiment the bar 16 includes a continuous horizontal surface 18 where it is common for patrons to have drinks.

As already noted, bar top video gaming terminals or devices are known and operate many versions of video poker card games and other single player games such as keno and bingo. In this embodiment, each bar top terminal 14 is preferably constructed with an INTEL compatible processor, running a WINDOWS operating system, a touch screen monitor/interface 20 for a player to enter game options, preferably one or more button inputs for player options, a currency acceptor and for accepting currency and player ticket vouchers, and a ticket printer for printing player ticket vouchers. These types of terminals are disclosed, for example, in the aforementioned U.S. Pat. Nos. 5,688,174, 6,921,337, 7,201,661, and 7,575,512.

Preferably, all components used in the bar top terminal 14 are in operative communication with the application software. Such development software as VOS.Net Framework enables components such as bill acceptors, buttons, and printers to easily integrate with application software via API calls.

The multiple bar top video gaming terminals 14 are preferably networked using techniques that are well known in the art. In particular, a simple LAN is established so that all the terminals 14 can communicate. Each application can have communication with one or more remote applications across the network. In addition to the disclosed LAN network, the internet can be the network upon which any of the methods disclosed herein can be connected.

Client/server based games are also known. Client terminals enable multiple games to be selected and downloaded from a server. This technology can be applied with the methods disclosed herein. Numerous multiplayer and single player card game options can be selected at the bar top and/or station terminals 14 and either downloaded for play at the bar top location or activated and run upon the server. In this first preferred embodiment, one or more of the bar top terminals 14 are in operative communication with an additional game processor that is running a multiplayer video gaming application such as is disclosed in U.S. Pat. Nos. 5,688,174, 6,921,337, 7,201,661, and 7,575,512. The multiplayer video gaming application and processor display game output on the common display 12 as shown in FIG. 1.

Video gaming applications are known. Programming languages such as VISUAL STUDIO can be used to write gaming applications. It is preferred herein that event driven operating systems such as WINDOWS XP and WINDOWS 7 be utilized with VISUAL STUDIO development languages such as VISUAL C# and VISUAL BASIC.

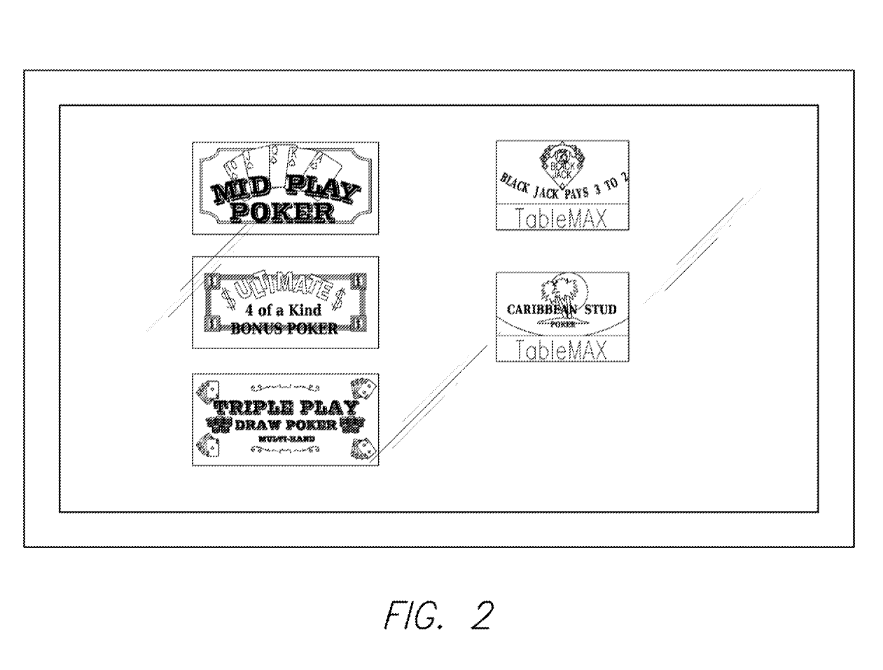

During operation, after inserting currency or a ticket of value to establish credits upon the terminal, a player can choose to play various game options. The software in operation upon the bar top terminals 14 initially presents two or more gaming options to a player. A first gaming option as illustrated in FIG. 2 enables a player to play a single player card game upon the terminal 14. A second gaming option as illustrated in FIG. 2 enables a player to choose to enter a multiplayer electronic table card game.

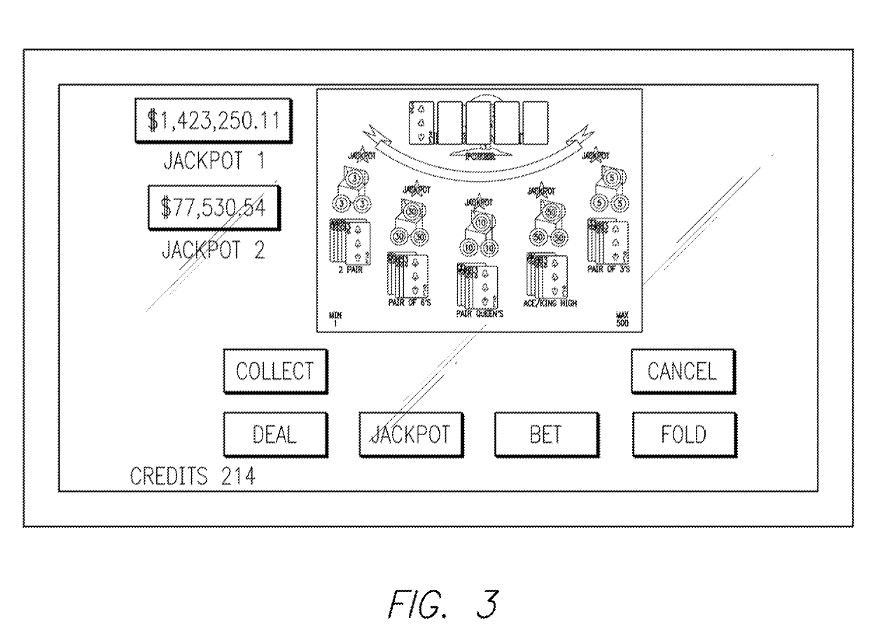

Upon selection of the option to enter a multiplayer card game sold under the trademark “TABLEMAX” as illustrated in FIG. 2, the player's terminal 14 displays a control input display to enable the player to become an active player in the multiplayer card game and enter game play decisions. Additionally, during the multiplayer control display mode, it is preferable that an overview of the activity of the electronic table card game is displayed upon the common monitor 12 shown in FIG. 1, as well as, on the player's terminal touch screen monitor/interface 20 as is illustrated in FIG. 3. The preferred overview will be that of looking at a live casino card table from an overview perspective. The view will include all table wagers positions, the table felt, and the chips and cards of all players in play.

The player will enter his game decisions via the touch screen monitor/interface 20 and these messages will be communicated via the bar top terminal 14 to the game processor running the multiplayer video card game application. Preferably, known messaging techniques are used to communicate between the various applications running upon the processors across the network. For example, in the preferred embodiments, IP messages using the UDP protocol are used to communicate between the various applications running upon the processors across the network.

The above described system 10 including one or more bar top gaming devices 14 and at least one common display 12 displaying card game activity operate to enable play of a multiplayer casino card game. This system is intended to be marketed under the trademark BARMAX. For illustrative purposes, the multiplayer card game being played in this embodiment is the game of blackjack, though any casino card game played upon a casino card table could be used with the current methods. Blackjack is available in many numerous versions and is known by those skilled in the art.

The blackjack game application will be operating upon the game processor displaying at least some of the output to the common monitor 12. Play of the card game of blackjack begins with each player(s) placing wagers to enter the game via the input options at the respective bar top player terminals 14. Wagering options preferably include a progressive side bet wager. At this stage of wagering all active ones of the terminals 14 enable a player to enter a wager to enter the next round of game play.

Upon a player entering a wager, the bar top terminal 14 creates a unique message and sends this to the game processor application terminal, where it is used by the blackjack game application. Preferably, the view upon the common display 12 is that of an overview of a live table game showing all players wagering locations and cards. The common display 12 is preferably located vertical to the player positions in an ergonomically optimal location such that each participating video bar top terminal 14 will benefit from an acceptable view of the common display 12 to each player.

As each player in the blackjack game wagers at their respective bar top terminal 14, there will be graphically displayed on the common monitor 12, a chip representing the wager placed by the player(s). In other words, each player's wagers are displayed upon the common display 12 as they are entered at the bar top terminals 14 in the multiplayer game. At each player's bar top terminal 14, messages such as “Press Deal” and “Enter Bet” can be displayed uniquely to the player on the terminal touch screen monitor/interface 20 to assist in facilitating game play. These messages can be unique to the player input terminals 14 and not displayed on the common display 12 that is viewable by all players.

Upon each player's bar top terminal 14 that is engaged in the multiplayer card game, a 2^{nd} graphic display area displays the same overview of the card table as is displayed upon the common monitor 12. For illustrative purposes the number of players in this embodiment of the multiplayer game is 3, but it will be understood that any number can be utilized. Each bar top terminal 14 in the multiplayer game has a dedicated position upon the common display 12 that represents a position as if at a live table game. For example, the three player stations counting from right to left will be player stations 1, 2 and 3. These will be represented upon the common display 12 upon the view of the card table surface with betting areas from right to left as 1, 2, and 3.

Upon all wagers being placed by the players, each player enters an input preferably identified as “Deal” to instruct the blackjack game application that the respective bar top terminal 14 is ready for game play. Upon a player pressing “Deal”, the player's bar top terminal 14 creates a unique message and sends this across the network to the multiplayer game application located on the game processor terminal. Upon all bar top terminals 14 entering a “Deal” command and communicating with the game application processor, a message is sent to each bar top terminal 14 from the game application indicating that play has begun. In response to the message that all wagers are placed and play has begun, the player terminals 14 are deactivated from being able to enter any game inputs.

Next, the game application deals cards to each player in the game. The cards are dealt starting with the bar top terminal 14 farthest to the right and continuing to the bar top terminal 14 farthest to the left. Just like a dealer deals the cards from the dealer's left to right in a live table game, the game application deals one card to each active terminal's representative location upon the table depicted in the common display 12 as described above.

After a first card is dealt to each player, a first dealer card is dealt. A second round or dealing is commenced to deal each player a second card initially which is common with the game of blackjack, and then the dealer hand is dealt the 2^{nd} card as well. The dealer's cards can be dealt face up or down; in this preferred embodiment the dealers 1^{st} card is dealt face down.

After all initial cards have been dealt, the game application then sends a unique message to the first bar top terminal 14, represented upon the common display 12 as wagering station 1, to instruct the first bar top terminal application to activate player input decisions for entering game play decisions. The player at this first bar top terminal 14 then can enter game play decisions such as “Hit”, “Double”, “Stand” or “Split” and play the player's current hand. Upon selection of game play options, the common monitor 12 displays graphical representations of the player's game inputs. For example, as the player enters “Hit,” a new card is drawn to the player's respective hand and illustrated on the common display 12. This same view is updated upon each player's terminal monitor 20. Game play decisions are unlimited and unique to rules of each card game. Preferably, upon the first player pressing “Stand,” the player signifies the completion of the player inputs.

Upon the player entering “Stand,” a unique message is sent from the respective bar top terminal 14 to the blackjack game application. At this time the game application sends a message to the player station bar top terminal 14 that disables that player station from entering any more game inputs.

Alternatively, in the game of blackjack should a player exceed the count of 21, the player would be automatically marked completed by the multiplayer card game application and restrictions would be applied to restrict the player from entering any more game input decisions. In one preferred embodiment the game application would send a message to the player's bar top terminal 14 causing the terminal to halt game inputs.

The game application then selects the next bar top terminal 14, preferably in sequential manner going as described before rightmost to left, which is actively engaged in the blackjack game. It then sends a message to this bar top terminal 14 enabling the terminal to activate and accept player input decisions.

It is noted that a likely scenario is that some of the bar top terminals 14 will not be in the multiplayer game, but rather will be occupied by single player game players. In this situation the blackjack game application will skip these terminals and go to the next bar top terminal 14 of the active blackjack game participant. For a further example, if the 3 players participating in the blackjack game are seated at a bar top area with 5 terminals numbered right to left 1-5, these terminals are occupied by 5 player's total. At terminals 1, 3, and 5 are the blackjack game participants. At terminals 2 and 4 currently single player game participants are playing other single player games. In this example control for entering player game play inputs would flow from terminal 1 (player 1) to terminal 3 (player 2) and finally to terminal 5 (player 3).

The game application thus enables a flow of player activity such that, play progresses from one active player terminal 14 to the next to enable each terminal 14 to operate in a sequential, often referred to as round robin, manner just like a live blackjack table. Further, each active player will play out their respective blackjack hand and control will rotate to the next bar top terminal 14 until such time that the last player station represented on the common display 12 has played their hand. At this point each bar top terminal 14 will be deactivated from entering player input decisions. Preferably, the game application has sent messages and instructed each bar top terminal 14 to deactivate any player input.

The blackjack game application will then take control of the game play and play the dealer's hand pursuant to a set of rules, taking dealer “Hits” or “Stands” as needed to play the dealer hand to completion. After the dealer hand is played the application will settle wagers at each bar top terminal 14. The activity of settling wagers typically includes players receiving credits and or forfeiting credits that were wagered. Preferably, this activity will be graphically represented on the common display 12 with player station wagering areas either having chips removed or chips awarded for various game outcomes.

For illustrative purposes, if the dealer hand busts by exceeding the count of 21, in this preferred embodiment each bar top terminal 14 would then receive a unique message from the game application that details a credit value to be awarded to the respective bar top terminal 14. It is desirable that payback of credits to the player stations will be from the right to left of the dealer, that would be from the left of the display to the right starting with station 3 and ending with credits awarded to station 1. Note that any method of payback and wagers are allowable within this method.

As credits are awarded to each player station, a graphical representation of casino chips is displayed upon the common display 12. For example, if player at wagering area 3 receives 10 credits from the prior wager, a chip(s) of a unique color predetermined to be associated with a chip value is displayed upon the common display 12 to signify a payment of 10 credits. In a preferred example, a red chip labeled with 10 would be displayed upon the common display 12 with the award of 10 credits to a respective player bar top terminal 14.

If the game play outcome results in the dealer hand beating the player hand count, each player station and respective bar top terminal 14 would not receive credits awarded and would lose the credits wagered at the start of game play. In this method of operation, the common display 12 would have the wagers previously wagered in the prior game displayed as casino chips. Upon forfeiture of a losing wager, the chips representing the wagered amount at a respective bar top terminal 14 would be deleted from the table view upon the common display 12.

Upon the settling of all wagers and each bar top terminal 14 being credited or not credited with new credits as per game play outcome accordingly, game play depicted upon the common display 12 is then cleared leaving a clean table view with preferably no chips or cards. The desired view is that of an overview of a clean card table felt with no play activity. At that point, a message is sent by the game application to each bar top terminal 14 enabling wagers for the next round of game play to be accepted. As each bar top terminal 14 receives said message, the player input ability to wager upon the next round is activated for the player.

II. Method of Operating Bar Top Gaming Terminals to Enable Play of Both Multiplayer Casino Card Games Using a Common Display and Single Player Games Simultaneously

In another method of operation, a player may play one or more single player games upon one of the bar top terminals 14, while simultaneously also playing one or more multiplayer card games. In this scenario, while a player in the multiplayer game is currently in a state whereby control has been presented to his bar top terminal 14 for multiplayer game input, the bar top terminal 14 can, for example, illuminate the respective player's input area to call attention to the fact a multiplayer game input is required. Likewise, a bar top terminal 14 can restrict or disable any single player game input during a time period when the bar top terminal 14 is actively required to enter multiplayer game input. This can be accomplished easily by simply having the display of the bar top terminal touch screen monitor/interface 20 segmented to enable one area of input while disabling the other area from any player input.

In one preferred embodiment the bar top terminal(s) 14 each utilize on their touch screen monitor/interface 20 a programmed window for each active game, enabling and disabling the window as needed to restrict or enable player input. Likewise, the bar top terminal 14 can present a graphical view of only the required multiplayer input area as is needed to facilitate the flow of the multiplayer game. This could be easily done by maximizing or altering the size and location of the multiplayer game input window using known programming techniques in the art of visual programming development.

In another variation, in addition to playing multiple single player games in various windows, a player can enter input for a more than one multiplayer card game. In this embodiment, the players would have multiple touch screen areas to enter respective multiplayer card game input. For example, if a player wanted to play both a multiplayer Caribbean Stud Poker game and a Progressive Blackjack game then the player could do so and simply enter wagers and game play options in unique areas of the touch screen enabled bar top terminal 14. Further, the terminal input application that is used to allow player input decisions could dynamically change to allow players to enter player game input decisions of both single player and multiplayer games. This application could change responsively to the event of a game decision being needed to be entered. Alternatively, the application could operate in a sequential manner with respect to the single player games that the player is actively playing while applying priority to required multiplayer game inputs by dynamically changing to an active multiplayer game input configuration as needed in an event driven manner.

It is also envisioned that a method of the common display 12 changing the displayed game to accommodate periodic display of all multiplayer card games currently in play could be utilized. In this embodiment by way of example, if three multiplayer card games were being played by five players at five of the bar top terminals 14, then each multiplayer card game would be rotated to be displayed upon the common display 12 for all to see. For example, if the three games were blackjack, poker, and baccarat, then the common display 12 would at the end of one or more rounds of game play of blackjack switch to display the overview depiction of all game activity for the active poker game. Thereafter the common display 12 could switch at the end of a round of poker to display for a period of time the active multiplayer game of baccarat.

Likewise, the common monitor 12 can be utilized for the current multiplayer game that has the most active participants. For example, if 3 players were playing blackjack and two were playing poker, then the common monitor 12 could dedicate the display to the blackjack game by the game application utilizing a count of active players of a unique multiplayer card game in an algorithm to determine which card game to display upon the common display 12.

It is also envisioned that the individual bar top device display 20 can be used for players to play multiplayer card games that aren't currently displayed upon the common monitor 12. In this embodiment, players simply utilize the bar top terminal monitor's view of the overview of multiplayer card game activity in order to play the game. This method of operation enables the system 10 to offer multiple multiplayer card games simultaneously. In one embodiment, the common view of each unique card game that is also displayed upon the common monitor 12 intermittently in the case of multiple card games, can also be displayed in the control area of each respective multiplayer card games' player input control area upon the player bar top terminal touch screen monitor/interface 20. In this way, the control will be easily identifiable to the respective game the players are playing.

In another preferred embodiment, it is possible for a player to place a wager before the start of the next round of a game. This will enable the players' wagers to be accepted at the start of the next round of game play to be displayed accordingly on the common display 12 and on each bar top display's common view, and then the player will be counted ready for play. It is envisioned at the end of a round of game play upon the multiplayer card game accepting new wagers, the player can be provided with an option to simply preferably press “Deal” or alternatively some other single input entry at the bar top terminal 14. In response, the terminal 14 will communicate a unique message to the game application whereby the game application will place the player's last wager and count the player ready for game play in the next round forthcoming. This method will accelerate game play and minimize network traffic commands.

It is further preferred that as the bar top terminals 14 are activated to enter player decisions and deactivated accordingly as control moves to the next player's bar top terminal 14, graphical representation of control be displayed at the active player station. This can be illumination of player inputs at the respective station or any graphical means of signifying that the current station is actively in the mode of entering game play decisions.

Although the card game of blackjack has been utilized for the foregoing illustrative example, it will be understood that the present invention and methods of play can be utilized to play any live table card game that is currently played upon live table games. Examples of these include, but are not limited to Three Card Poker, Let it Ride, Caribbean Stud Poker, Baccarat, and Poker.

Additionally, the present invention can facilitate play of other table card games such as Texas Hold'em Poker and Caribbean Draw Poker that require that each player's cards be held in confidence. In the operation of these games, the method utilized would enable the common monitor 12 and terminal monitors 20 not to display all players' cards in play until such time as rules of the specific games provide that each player's cards are to be revealed.

Additionally, multiplayer slots and other types of wagering games can be conducted upon the system 10 utilizing the method of game operation disclosed herein.

Although the preferred system 10 is configured to position the bar top video terminals 14 so that the common display 12 is ergonomically located to enable the terminals 14 to participate in the game with utilization of the common display 12, the system 10 can also provide multiplayer games without a common display option. In this scenario, players can utilize the view on the monitor 20 of the bar top terminal 14 to play against other players. Likewise, in a further variation, one or more displays of the table card game activity which is described as being displayed on the common display 12 herein, can be located in areas other than that of common view of the players such that others can watch the game play and learn how to play the games being played upon the system 10.

It is further envisioned that during a state of no game play or during game play, the common monitor 12 as described in this method of operation can be used to display sports or other broadcast activity other than that exclusively of the card game in play. It is also envisioned that multiple windows of card game activity can be displayed upon the common display 12 as well.

A summary of the steps to the method of operation of the disclosed system 10 within one preferred embodiment include: presenting one or more single player video game options upon a bar top terminal; presenting one or more multiplayer video table card game options upon the bar top terminal; upon a player selecting a multiplayer gaming option, the terminal providing a display that enables a player to enter a wager and participate in a multiplayer card game; presenting a graphical display of the said player's wager on a common display viewable to all players in the multiplayer game option; upon a player completing the step of entering a wager and said multiplayer card game being activated, the terminal providing a means of control of the player's activity in the multiplayer video table card game; graphically displaying an overview of a card table on both the common display and each bar top device display, a graphical representation of one or more wagers placed by each player in the multiplayer card game; graphically displaying an overview of a card table on both the common display and each bar top device display, a graphical representation of one or more cards being dealt in the multiplayer card game; and, exiting a multiplayer game selection and returning to a display upon the video bar top terminal allowing a player to choose from a menu of one or more single player games and one or more multiplayer game options.

III. Utilization of the Bar Top Processor to Run the Game for No Additional Device Count

In a further preferred embodiment of the invention, a BARMAX type system as described above, which can enable one or more bar top video gaming terminals to form and operate an electronic multiplayer card game utilizing a common display, is configured such that the game application software for operating the multiplayer card game and controlling one or more common displays will reside upon and be operated by one of the bar top terminal devices 14. This preferred method of operating an electronic table game will entail a common display in operative communication with one or more of the bar top terminals processor(s). In this embodiment, one of the terminals 14 will act as a server device running both the card gaming application that is displayed on the common monitor, as well as, operating the terminal application for the respective player terminal inputs.

This embodiment can be constructed by one skilled in the art by simply running game application software on one or more of the bar top gaming terminals 14. With each bar top gaming terminal 14 networked to each other, the game application can be operated as a server application interacting with one or more bar top terminals 14 that are running client application for operating the bar top terminal's player input application. The game application software displays game outcome on the common monitor 12. Additionally, the client applications running the terminal input software applications provide input means of player inputs at the respective terminals, but also, these applications are in operative communication with the game application in order to display an overview of the common display activity upon each terminal also.

In yet another preferred embodiment, the card game application will execute and operate on the bar top terminal game processor as an independent application. A second application that handles in part the player inputs to enter decisions into the multiplayer game as described above will also be executed upon this same bar top terminal's CPU via one or one or more processors operating there. A preferred processing means would be for each bar top video terminal 14 to have one or more INTEL compatible multi-core CPU processors installed and operating a WINDOWS operating system.

In this embodiment, the player input application will simply communicate with the multiplayer card game application via socket communication, just as it did in the previous embodiment. The only difference will be that the two applications, with unique socket address identifiers will be located on the same processing unit at the preferred one bar top gaming device.

This configuration, with all game application software residing upon one or more of the bar top gaming terminals 14, is optimal as many gaming jurisdictions locations have a limitation upon the number of gaming devices that are allowable per location. One example of this limitation will be in the route market in Nevada. This segment of the industry includes bars, restaurants, and convenient store locations. Most bars in the state of Nevada have bar top video gaming terminals installed in the bar tops. This preferred embodiment enables play of a multiplayer electronic table game by utilizing only the existing number of bar top gaming devices allocated to a particular establishment.

A further embodiment includes a progressive jackpot wager option that is available for players to place a progressive wager at the bar top terminals and enable the player to become eligible for a progressive jackpot award. Each function of the above operation of the described system is applicable to this configuration.

IV. Method Of Operating A Multiplayer Electronic Table That Allows Players To Play Individual Card Games At Each Station Like A Bar Top Game In Addition To The Multiplayer Card Game.

It is further envisioned that the above mentioned methods of operation of a bar top video gaming system, can be applied to multiplayer card gaming devices of multiple stations. For example, video tables marketed under the trademark TABLEMAX are electronic table gaming devices including one or more player stations and a common display for playing electronic versions of casino card games. This type of multiplayer interactive card gaming device is disclosed in U.S. Pat. Nos. 5,688,174, 6,921,337, 7,201,661, and 7,575,512 referenced herein. In this embodiment, each player station at a multiplayer electronic card table device can be populated with a processing device, touch screen display, and other player input devices. Each player station can be constructed like the aforementioned bar top and common display apparatus, such as a BARMAX system, so that players can choose at each player station from one or more single player games and one or more multiplayer games. Each of the methods disclosed above for the BARMAX type systems can be applied to the multiplayer card gaming devices such as a TABLEMAX video table.

V. Method of Operating a Progressive Card Game for Both Bar Top Enabled Multiplayer Casino Card Game and a Multiplayer Video Table Device

A progressive jackpot feature can also be offered with the method of combining the progressive jackpot amounts for both the multiplayer games and the single player card games disclosed herein. This ability to combine the progressive amounts from both versions of games will enable greater play as players of both single player and multiplayer versions will be offered increased jackpot values.

Progressive jackpots utilizing side bet wagers are known to those skilled in the art. Caribbean Stud Poker, Let it Ride, Three Card Poker and many other live casino card games utilize this method. The known method entails allowing a player to place a separate side wager prior to a card hand being dealt. Should the card hand dealt be a hand of a predetermined value, an award is paid. It is known in the art, that increasing a progressive jackpot award by a percentage of the wagers placed upon the side bet wager is a popular attraction for players. Likewise, video poker games with progressive jackpot features are also known by those skilled in the art.

As previously stated, numerous video poker games exist and are often the most popular options presented on bar top video gaming devices. These single player video card games such as Jacks or Better, Deuces Wild, and Bonus Poker are just a few of the dozens if not hundreds of video poker versions available on gaming devices at present.

Many video poker games operate in a manner that is different from that of a live casino card game. The difference is in that often, video poker games do not require a progressive side wager in order to win a progressive jackpot. For example, Table 1A below shows a typical pay table for a video poker game named Jacks or Better.

TABLE 1A
Jacks or Better Video Poker Pay Table (No side wager for progressive
Jackpot pay)

| Hand | Payoff |
|---|---|
| Royal flush | Jackpot |
| Straight flush | 50 |
| Four of a kind | 25 |
| Full house | 9 |
| Flush | 6 |
| Straight | 4 |
| Three of a kind | 3 |
| Two pair | 2 |
| Pair | 1 |
| Nothing | 0 |
| Total | |

TABLE 1B
Caribbean Stud Poker Progressive Side Wager Table (Requires a
separate side wager for progressive Jackpot pay)

| Hand | Payoff |
|---|---|
| Royal flush | 100% of Jackpot |
| Straight flush | 10% of Jackpot |
| Four of a kind | $100 |
| Full house | $75 |
| Flush | $50 |
| Straight | $10 |
| Three of a kind | $3 |

It is known by those skilled in the art that a player places a wager, typically 1 to 5 credits, upon the machine. The player then presses a deal button and/or is counted ready by placing a maximum wager. When a player wins an award in video poker, the original wager is not returned; rather the player's credit account is simply credited with the win.

Variations of video poker exist whereby if a player places a maximum wager, then the player's top line award becomes a progressive jackpot value. It is known that video poker devices contribute a percentage of every wager and/or play to increment the progressive value offered to players.

Upon a live casino card table such as Caribbean Stud Poker, a player places a game wager upon the card game and typically also a 2^{nd} wager upon the side wager area for a progressive win as illustrated in TABLE 1B. If a player wins an award during game play, the players game play wager is returned with an odds based multiple of the wager placed. Odds such as 2 to 1 for a hand of Two Pair are an example.

In regards to the progressive side wager upon a live table, the wager is typically placed and forfeited at start and should an award be paid, the posted amount is paid without return to the player, similar to the manner progressive video poker games operate.

Therefore the single player games and multiplayer games operating in the disclosed manner herein can utilize common progressive values between both the single card game plays and multiplayer card game wagers. Both these games can contribute to and increment the progressive values offered to players during game play.

For example, consider the multiplayer card game option of Caribbean Stud Poker. An example progressive pay table will pay the player a jackpot upon a side wager being placed and the player being dealt a royal flush. Those skilled in the art know that the odds of obtaining a royal flush with a one deck card game are approximately 649740 to 1. The same is true for the single player video poker game of Bonus Poker. This game is also a one deck card game and typically pays a player a progressive jackpot value should the player be dealt a royal flush. Therefore, as both Bonus Poker and Caribbean Stud poker share the same odds of a progressive jackpot win, the win amounts from play of both games can be shared and offered to players of either game. Likewise, the contributions of play from both games can be applied to the common jackpot total. Therefore, the progressive value will increase faster with play from both players of single player games and multiplayer games.

Further, the requirement of a video poker player having to wager a predefined amount in order to be eligible for the progressive win can also be applied to the multiplayer card games. In one preferred method, it might be required that a player wager a certain game wager total before being eligible to wager the progressive side bet wager in an electronic multiplayer card game. Further, one can require a single player video poker card game player to wager a required amount prior to being eligible for the progressive jackpot in combination with allowing multiplayer card game players to be eligible with simply a progressive side wager and no game play wager minimum is an option.

A progressive jackpot can also have a special pay based upon whether a player is playing both a single player card game and a multiplayer card game simultaneously. In this embodiment, should a player be playing a single player game, as disclosed previously, while also playing a multiplayer card game and the player receives a predetermined outcome then the player can be eligible to receive an award for this event.

Conditions such as the player having played a wager upon one game in a prior time period or within a number of rounds of play can also be utilized as rules for award pay. A progressive jackpot award can be awarded based upon in part, the number of multiplayer game player(s), the number of single player game player(s), and/or any combination of the two that are playing the bar based system 10 or a similar table based system at any one time during the event of a progressive award being obtained.

For example, consider if the system 10 pays a double award when a jackpot value hits should all the player positions be populated with only multiplayer table game players instead of some stations being occupied by single player game players. Consider should a casino desire to maximize the play of certain multiplayer card game players, versus that of single player games upon the system 10, due to the fact hypothetically that say the multiplayer game options are more financially attractive for the casino operation. Then with the system 10 or a similar device, an award can be offered that is based upon the criteria that if during game play a predetermined event occurs, should the maximum number of stations available all be currently in active game play and all such stations are playing in a multiplayer card game, then the award paid for the said event could or will be doubled.

Likewise, utilizing the number of currently active multiplayer card game players(s), the number of single player card game player(s), and/or the number of empty player(s) positions in the system 10 is also a condition upon which game play awards can be paid.

Further, limits upon live card tables are known. It is common that a casino card table will have a 5, 10, or 25 dollar minimum wager amount required. Often these values change during the day with different time periods and demand for live table game play within the casino. With this in mind, the system 10 can be operated in a manner whereby the method of utilizing the number of active players in proportion to total players possible on the system and what games the players are playing can be used as a criteria to affect the required minimum wager amount(s) upon either the multiplayer card game(s) or the progressive side wagers. By further example, should a five player table based device be occupied with five players, each playing the game option of Caribbean Stud Poker and thus having 100% capacity filled, then the device could lower the required minimum wager from a required amount of 5 dollars per hand to 1 dollar per hand.

Likewise, the system 10 or a table based device can use a method based upon a criteria of the maximum number of seats being at a predetermined level of occupancy. The system 10 could then offer lower denominations of games such as the single player games options. For example, it could enable a wagering option of 5 cent credit games at such time of full occupancy whereas before the criterion is met the minimum single player games could be 25 cent credit games. This enables profit maximization from operations.

Furthermore, a live casino card table, the system 10, or any other multiplayer card gaming device/system could utilize the number of active players as a percentage of the total player positions available for game play as a criteria to lower the required progressive side wager option required to enter and be eligible for a progressive jackpot award. In an example, a multiplayer video card game displays a $100,000 jackpot award and the side wager required to enter and be eligible for the award is $1. Upon a maximum number of players being on the device and playing the same multiplayer card gaming option, the required wager for the progressive jackpot could be reduced to 50¢. This can be applicable to any or all awards posted upon the device in addition to the top level progressive award. These methods of progressive card game play can be utilized with the disclosed methods herein related to either a multiplayer electronic card table, such as the one marketed under the trademark TABLEMAX, or a bar top device network and a common display, such as the system 10 disclosed herein.

Although the present invention has been disclosed in terms of a number of preferred embodiments and numerous variations thereon, it will be understood that numerous other variations and modifications could be made thereto without departing from the scope of the invention as set forth in the following claims.

1. A method of operating a bar top video gaming terminal, including:
a) Presenting one or more single player games to a player
b) Presenting one or more multiplayer card games to a player
c) Providing a common display for displaying an overview of game activity of said multiplayer casino card so that each player at said bar top video terminals can view said common display
d) Upon selection of a multiplayer card game option, a player's respective bar top terminal enables an input means for communicating player game play decisions in said multiplayer card game.

2. The method of claim 1, including a 2^{nd} view of game overview activity at each said terminal.

3. The method of claim 1, whereby each terminal is configured such that when a multiplayer game is selected an overview of game activity is displayed upon the common display and players can also play a single player game in a separate area of bar top terminal.

4. The method of claim 1, whereby the terminal is operated in a manner that when a player in a multiplayer card game is eligible to enter player game inputs, the multiplayer input display is visually altered to alert the player they need to enter input and keep the multiplayer game going.

5. The method in 3, where the software restricts or freezes entering any data into the single player game, while the player terminal is the active player in the multiplayer game.

6. The method of claim 1, where the game application is in operative communication with each bar top terminal and instructs each terminal application to allows or restrict input of players' decisions.

7. The method of claim 1, where by player input decisions are entered in a round robin manner.

8. The method of claim 1, where player credits are award to terminals in a sequential manner.

9. The method of claim 1, wherein displaying a 2nd overview of game activity upon each player station terminal actively in said multiplayer game.

10. The method of claim 1, whereby one or more players can play single player games upon their respective player terminal, while one or more players play said multiplayer card game using their respective terminals to enter multiplayer game inputs.

11. The method of claim 1, wherein a player can select to play a multiplayer game at any time, but when an active multiplayer game is being operated, said new player(s) enter the multiplayer game after at the end of each round of play before the start of a new betting round of play.

12. The method of claim 1, where upon one or more players choosing differing multiplayer card games, players can play the multiplayer card game utilizing the said overview of game play activity displayed at said player terminal.

13. The method of claim 1, where upon one or more players choosing differing multiplayer card games, using a count of active players of each multiplayer game to determine which game is displayed upon the common display monitor.

14. The method of claim 1, where the common display output is used to intermittently display one or more multiplayer card games actively in play.

15. The method of claim 1, whereby players can play multiple multiplayer card games at the same time.

16. A method of operating a multiplayer video card gaming device including
a) Providing a common display for viewing game activity of one or more players together;
b) Providing player stations whereby players can enter game inputs and at least one or more player stations offers at least one player option to play a single player card game and/or one player option to play in a multiplayer card game;
c) Upon a player selection of playing said multiplayer card game, configuring player station terminals input device to provide a control means to enter facilitate play of said multiplayer card game
d) Displaying upon the common monitor an overview of game activity of each player in said multiplayer game, including displaying at least some of the cards dealt and currently in play.

17. The method of claim 16, wherein displaying a 2nd overview of game activity upon each player station terminal actively in said multiplayer game.

18. The method of claim 16, whereby one or more players can play single player games upon their respective player terminal, while one or more players play said multiplayer card game using their respective terminals to enter multiplayer game inputs.

19. The method of claim 16, wherein a player can select to play a multiplayer game at any time, but when an active multiplayer game is being operated, said new player(s) enter the multiplayer game after at the end of each round of play before the start of a new betting round of play.

20. The method of claim 17, where upon one or more players choosing differing multiplayer card games, players can play the multiplayer card game utilizing the said overview of game play activity displayed at said player terminal.

21. The method of claim 17, where upon one or more players choosing differing multiplayer card games, using a count of active players of each multiplayer game to determine which game is displayed upon the common display monitor.

22. The method of claim 17, where upon one or more players choosing differing multiplayer card games, rotating the multiplayer game actively displayed upon the common monitor to include one or more multiplayer games actively being played at one or more said player stations.

23. A method of operating a progressive jackpot feature for a multiplayer card game including:
a) Providing one or more options for players to play a single player video game
b) Providing one or more options for players to enter into and play a multiplayer video card game
c) Enabling progressive values to be shared between the single player video poker games and the multiplayer casino card games
d) Enabling progressive contributions to a common progressive pool from one or more single player video games and one or more multiplayer card games.

24. The method of claim 23, whereby the single player games are video poker games without a side bet wager that allow a player to win a progressive if a certain wager level is made and the multiplayer games are casino card games that require a side bet wager to be eligible to win the progressive jackpot.
